(19) United States
(12) Patent Application Publication
(10) Pub. No.: US 2015/0108168 A1
(43) Pub. Date: Apr. 23, 2015

(54) DISPENSER FOR A PUMPABLE FLUID

(71) Applicant: STH DEVELOPMENT & DESIGN AB, GÖTEBORG (SE)

(72) Inventor: Santosh Truedsson, Goteborg (SE)

(73) Assignee: STH DEVELOPMENT & DESIGN AB, Goteborg (SE)

(21) Appl. No.: 14/403,851

(22) PCT Filed: May 21, 2013
(86) PCT No.: PCT/SE2013/050573

§ 371 Date: Nov. 25, 2014

(30) Foreign Application Priority Data
May 25, 2012 (SE) 1250534-3

(51) Int. Cl. A47K 5/12; B05B 11/00

(52) U.S. Cl. CPC A47K 5/1211; B05B 11/0027; A47K 2005/1218
USPC 222/153.13; 222/173; 222/321.1; 222/333

(57) ABSTRACT

A dispenser (2) for a pumpable fluid (3), such as dishwashing detergent, soap or cooking oil, arranged at a sink unit, a work top, a cupboard, a wall, a sink, a bathtub or another similar surface (4), and that includes a movable discharge mechanism (5) for the fluid (3). The discharge mechanism (5) is receivable in an inserted concealed storage position (I) inside the surface (4) and in a projected, from the outside (6) of the dispenser (2), freely accessible discharge position (II), respectively, the discharge mechanism (5) including a pump (7) that is arranged to take a locked pump position and an unlocked pump position, respectively.

### TECHNICAL FIELD OF THE INVENTION

The present invention relates to a dispenser for a pumpable fluid, such as for instance dishwashing detergent, soap, cooking oil, adapted to be arranged at a sink unit, a work top, a cupboard, a wall, a sink, a bathtub or another similar adjacent surface, and comprises a movable discharge mechanism for said fluid.

### BACKGROUND OF THE INVENTION AND PRIOR ART

There is a wish to be able to handle pumpable fluids of the above mentioned type in a simple and efficient way, easily accessible at areas suitable for this, for instance at a sink unit and then by the side thereof. Normally a bottle of dishwashing detergent is placed at the sink unit, from which bottle one pour wanted amount during washing-up. Similar is the case at other places where one use fluid in bottles and which fluid is discharged by being pumped out with suitable amount according to above mentioned products and places.

It is known to arrange pumps at the edge of for example sinks, on sink units and other similar places. For instance US 2007/0246486 A1 discloses a dispenser at a sink unit for discharging dishwashing detergent from a concealed retainer located below said sink unit.

U.S. Pat. No. 6,568,569 B1 discloses a soap pump at a wash basin.

US 2008/0302823 A1 and BE 810408 disclose a kitchen or bath room applicable cleaning pump for cleaning liquid, which pump is mounted in a board.

However, it is not made possible with said known pumps to be able to entirely press down the pump part itself, which pump part normally is located in a raised position for the actual discharge of fluid at wanted occasions.

This is a drawback when one wants to attain the work top, sink unit, sink, etc. in question entirely free from protruding objects during for instance cleaning of the surfaces in question or in order to avoid that the work top, etc. is cluttered up by undesirable objects.

### OBJECTS OF THE INVENTION

The main object of the present invention is therefore foremost to by means of simple and well-functioning means solve among other things the above mentioned problems.

### BRIEF DESCRIPTION OF THE INVENTION

Said object is attained be means of a device according to the present invention that is mainly characterized in that said discharge mechanism is arranged to be received in an inserted concealed storage position inside said surface and a projected, from the outside of the dispenser, freely accessible discharge position, respectively, the discharge mechanism comprising a pump that is arranged to take a locked pump position and an unlocked pump position, respectively.

Preferred embodiments of the present invention are further defined in the dependent claims.

### BRIEF DESCRIPTION OF THE DRAWINGS

A more complete understanding of abovementioned and other features and advantages of the present invention will be apparent from the following detailed description of preferred embodiments with reference to the accompanying drawings, in which:

FIG. 1 schematically disclose the invention applied entirely lowered and concealed inside the upper surface of the board and having an underlying reservoir for e.g. soap,

FIG. 2 schematically disclose the invention in a projected use position to pump out dishwashing detergent,

FIG. 3 disclose a side view and a cross sectional view along the arrows, respectively, of a device according to the invention in the lowered storage position,

FIG. 4 disclose a side view and a cross sectional view taken along the arrows, respectively, of a device according to the invention in the projected use position to pump out the fluid concerned,

FIG. 5 disclose a perspective view, an elevated view from above and a side view, respectively, of a bottom gear ring,

FIG. 6 disclose a helical compression spring,

FIG. 7 disclose a pump mechanism in a perspective view, in an elevated view from above, a side view and a cross sectional view taken along the arrows, respectively,

FIG. 8 disclose a pump holder in a perspective view, a side view and in an elevated view from above, respectively,

FIG. 9 disclose a turn and lock body in a perspective view, an elevated view from above as well as a side view,

FIG. 10 disclose an exploded view of the entire device and a cross sectional view thereof taken along the arrows, respectively

FIG. 11 disclose a pump cap having a mouthpiece in a perspective view, a side view, an elevated view from above as well as a cross sectional view taken along the arrows,

FIG. 12 disclose an outer sleeve in a perspective view, a side view, an elevated view from above and a cross sectional view taken along the arrows, and

FIG. 13 disclose an inner sleeve in a perspective view, a side view, an elevated view from above as well as a cross sectional view taken along the arrows.

### DETAILED DESCRIPTION OF PREFERRED EMBODIMENTS

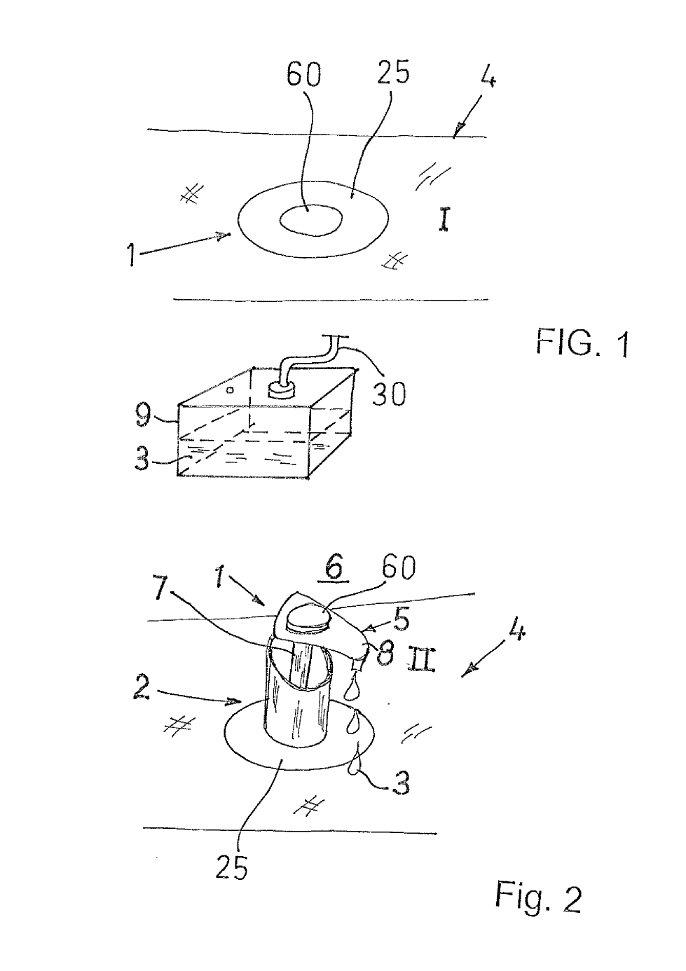

Reference is initially made to FIGS. 1 and 2, in which a device 1 comprising a dispenser, generally designated 2, for a pumpable fluid or liquid 3, and a surface 4, is schematically shown. The pumpable fluid is for instance constituted by dishwashing detergent, soap, cooking oil, etc., and the surface 4 is for instance constituted by a sink unit, a work top, a cupboard, a wall, a sink, a bathtub, or any other similar surface being adjacent the location where the fluid is intended to be used. The dispenser 2, that comprises parts and accessories which are arranged to accomplish its operative function, is arranged to be built-in in said surface 4 in a kitchen, a caravan, a boat, a bath room, etc.

The dispenser 2 comprises a movable discharge mechanism 5 for said fluid 3, which discharge mechanism 5 in FIG. 1 is located in an inserted concealed storage position I inside said surface 4 and in FIG. 2 is located in a projected, from an outside 6 of the dispenser 2, freely accessible discharge position II. The discharge mechanism 5 comprises a pump 7 having a mouthpiece 8 that for instance is connected to a reservoir 9 that for instance is located below the surface 4.

When the dispenser 2 and its pump 7 for the function thereof is integrated in for instance a work top 4 it shall in the storage position I be located in level with the work top, also known as flush. It shall in other words not protrude above the surface 4 in which it is mounted, but be located in level with the surface 4.

When the dispenser 2 shall be used one shall only need to for instance press at the top of the discharge mechanism 5 for it to appear such that one thereafter may use the pump 7.

When the discharge mechanism 5 shall take the discharge position II this takes place by one pressing on it and then it is released from the locked position/storage position I and appear by means of a spring force. The pump 7 will in its projected position have the mouthpiece 8, where the liquid medium exit, preferably about 60-110 millimeters above the work top 4.

The pump 7 is arranged to take a locked pump position and an unlocked pump position, respectively, and the change of state between the locked pump position and the unlocked pump position, respectively, may take place automatically/mechanically, manually or a mixture thereof. In the locked pump position the pumpable fluid will not be pumped out when the discharge mechanism 5 is pressed down to the storage position I, i.e. when the pump 7 is located in the locked pump position one can press down the discharge mechanism 5 such that it ends up in level with the surface 4 without any fluid being pumped out. In the unlocked pump position the pumpable fluid will be pumped out when the dispenser 2 is used. When the discharge mechanism 5 reaches the discharge position II, the discharge mechanism 5 and/or the pump 7 may for instance be turned in a first direction in order to accomplish the change of state from the locked pump position to the unlocked pump position. Upon turning in a second direction that is opposite the first direction, or upon continued turning in the first direction, of the discharge mechanism 5 and/or pump 7 a change of state is achieved from the unlocked pump position to the locked pump position.

When the pump 7 is refilled with the intended fluid 3, this may be done by filling up a refill reservoir 9 that is mounted below for instance the work top, alternatively it can be done by refilling the pump 7 from above by for instance first remove the actual pump and thereafter pour down directly into the reservoir in which the dishwashing detergent or soap is kept.

The pump may be composed of different materials, such as steel, plastic, ceramic, rubber, aluminum, etc.

Field of Application:

The pump shall be able to be used for various liquid substances such as soap, shampoo, hair conditioner, skin cream, dishwashing detergent, oils, vinegar, sauces, ketchup, etc.

Installation:

The pump may be installed both in a vertical position and in a horizontal position. This means that one may not only install it on a work top or a sink unit and sink but it shall also for instance be possible to have it built-in in a wall or in a cupboard. It shall also be able to be used on a table or the like, at for instance a restaurant, etc. When the dispenser 2 is installed on a work top 4, a sink unit or another similar board shaped base, first a hole is made in the board. Thereafter the dispenser 2 is inserted into the hole. The dispenser 2 may be kept in place by for instance being glued by means of a collar 25 or the like, but it shall also be able to be fastened by means of a tensioning device (not shown) that clamp it to e.g. the work top.

Maintenance:

On the dispenser 2 it is preferably arranged a rubber gasket (not shown) located under the collar 25, i.e. where the dispenser 2 rest against e.g. a work top in a suitable indentation. This rubber gasket shall stop liquid and moister from entering between e.g. the board and the dispenser 2 and destroying the work top. The discharge mechanism 5 shall preferably have a small rubber ring at the top which entail that in the storage position I, e.g. in the rest position when it is located at an even level with the work top, it shall work as a seal and prevent dirt and moisture as well as liquid from forcing its way into and flowing into the dispenser 2. The pump part itself in the pump application/product shall be able to replace. E.g. when one has used dishwashing detergent but wants to change to hand cream. Then the actual pump part and pump cap is exchanged. This is performed either by turning the pump cap and unscrew it or by pulling off the pump part together with the pump cap by means of a small jerk.

Mouthpiece:

In order not to have the pumpable fluid running down along the edge of the discharge mechanism 5, it may comprise a movable mouthpiece 8 that turn/fold out or projects when one press on the pump 7. Thanks to this the actual drawing off pipe or mouthpiece 8 will project a distance from the actual discharge mechanism 5 and this entail that one can place the palm under the mouthpiece 8. Alternatively, it may from the actual pump 7 project a pipe that the pumpable fluid ejects through. This pipe that projects will preferably be folded back and not visible when one not pump, but as quickly as one press the pump 7 and exert a force downwards the pipe will project. How much it project depend for instance on how much/far the actual pump is pressed down. Preferably the mouthpiece 8 does not project in the radial direction from the discharge mechanism 5, but the size and inclination of the mouth is dimensioned such that at a certain compressive force pump out the pumpable fluid at a certain speed that entail that it land at a suitable distance from the discharge mechanism.

Sensor Technique:

The pump shall be able to be operated by means of touch free sensor technique. This originates from when one wants some fluid, one may only place the hand under the mouthpiece, activate the sensor and thereby starting a discharge of the pumpable fluid into the hand.

Thereto, the actual discharge mechanism 5 shall be able to go up and down by means of an electric motor. Then the actual discharge is not managed by means of so called spring force. Also this hoisting and lowering shall be able to be operated by means of known sensor technique, e.g. when one sweeps the hand over the dispenser 2 the discharge mechanism 5 is moved to the discharge position II. Thereafter, when one is done using it and sweeps the hand again over the dispenser 2, or touch the discharge mechanism 5, the discharge mechanism 5 shall again be moved to the storage position I.

Different Types of Locking Mechanisms:

In addition to the now developed and hereinafter disclosed locking mechanism one may use other solutions, e.g. a small clip that locks it every time it comes down. Alternatively, one may push down the pump by hand and thereafter turn it manually to the side until it finds it locking position.

Below the invention is described more specified and in more detail, and with reference to the other figures.

A dispenser 2 intended for a pumpable fluid 3, such as e.g. dishwashing detergent, soap, cooking oil, etc., arranged at a sink unit, a work top, a cupboard, a wall, a sink, a bathtub, or any other similar surface 4, and by comprising a movable discharge mechanism 5 for said fluid 3 it is made possible to entirely conceal said discharge mechanism 5 such that it completely get out of the way at its storage location. More precisely, said discharge mechanism 5 is receivable in an inserted concealed storage position I inside said surface 4, and a projected, from the outside 6 of the dispenser 2, freely accessible discharge position II. Thus, the device 1 may be mounted in any intended location, and in any wanted position, i.e. horizontal as well as vertical, in a raised and in inversed position, respectively, or inclined.

The discharge mechanism 5 comprises a pump 7 having a mouthpiece 8 that e.g. is connected to a reservoir 9 via a conduit 30. The pump 7 comprises according to one embodiment means for making it possible to automatic projection or turning of the mouthpiece 8 of the pump 7 and said means may be constituted by a mechanically, electrically or manually manipulated drive unit.

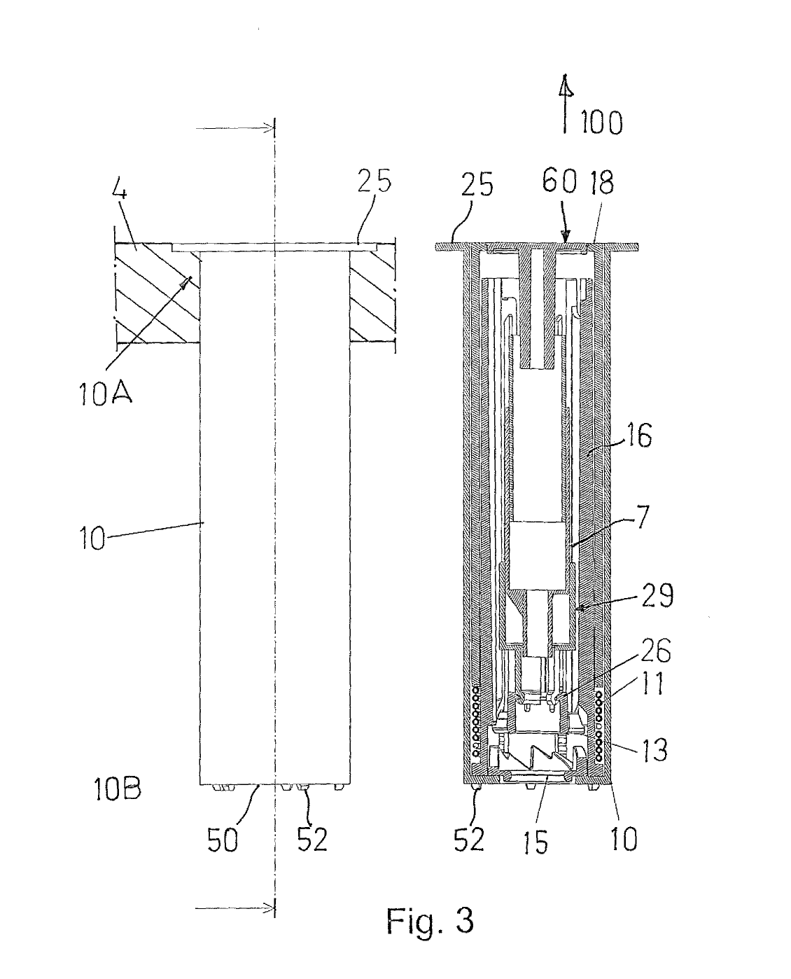

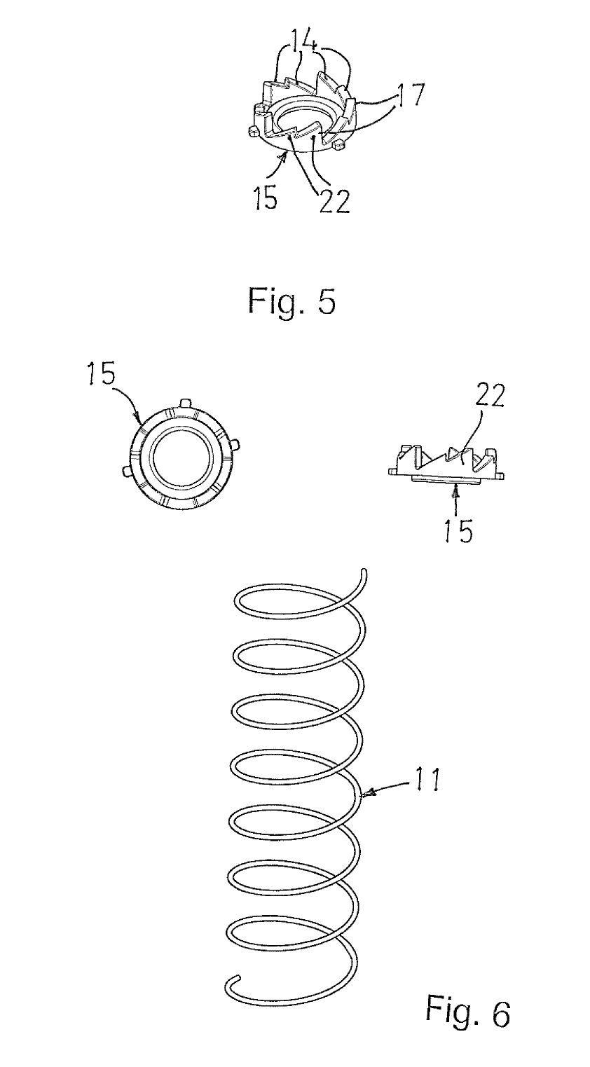

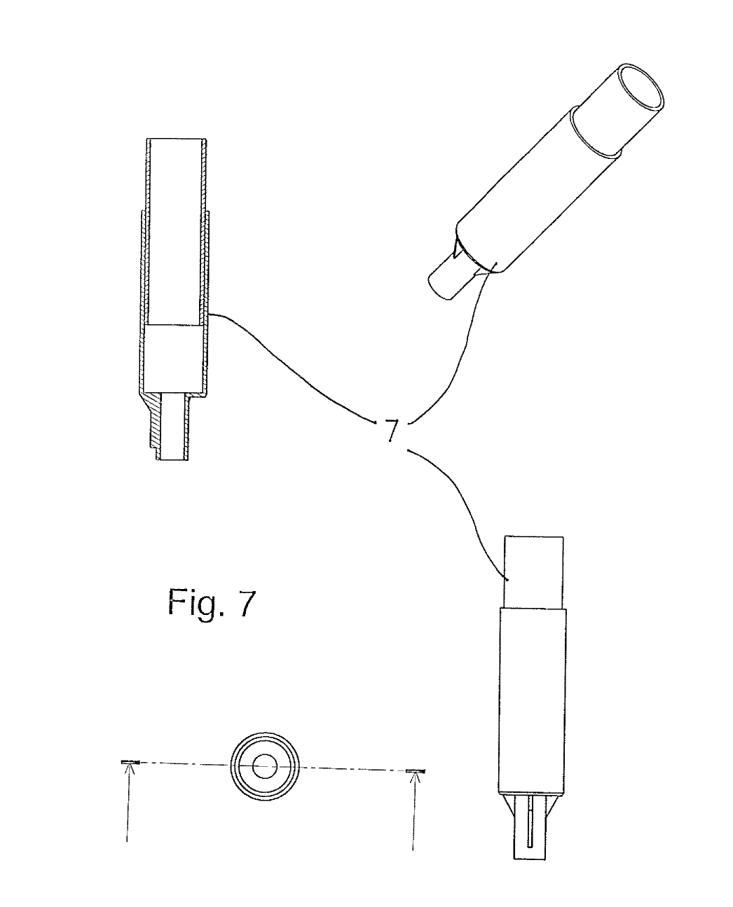

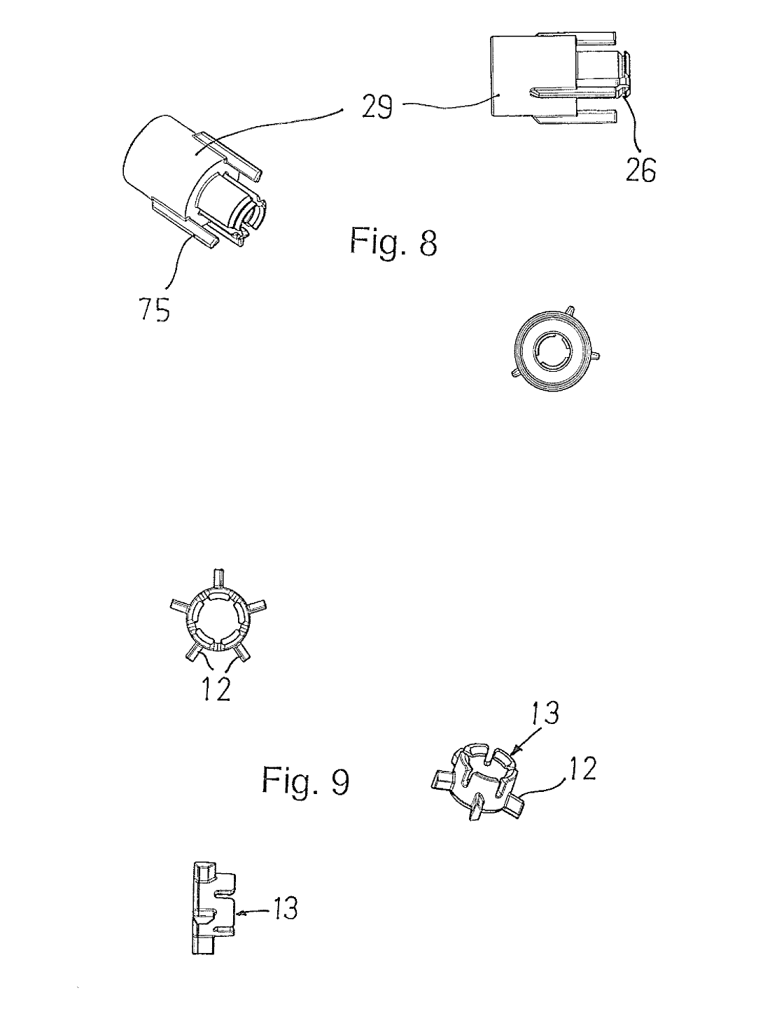

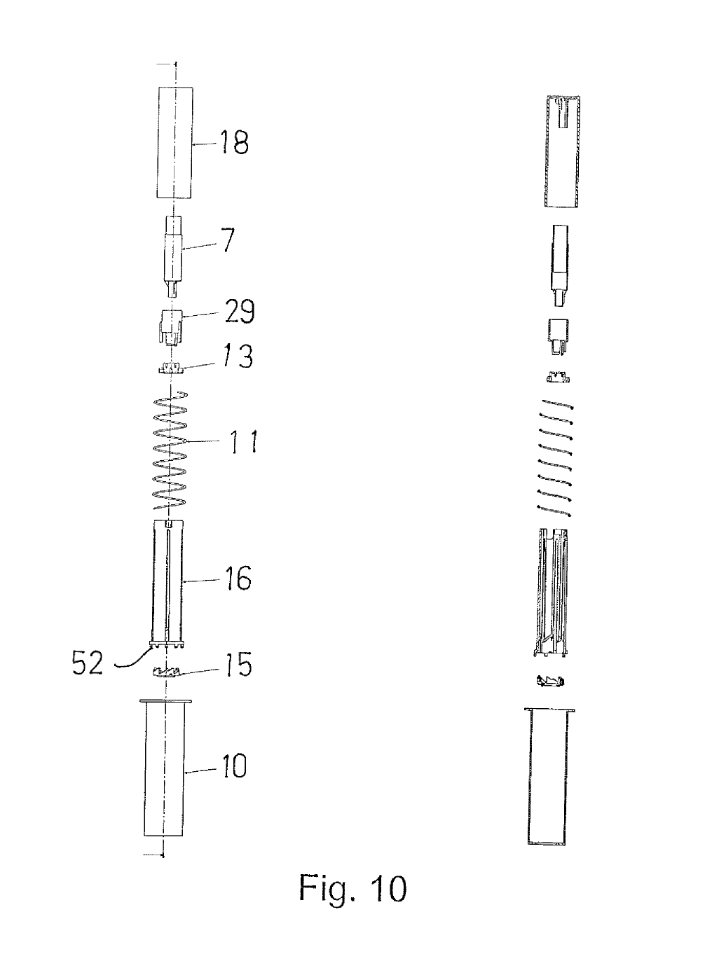

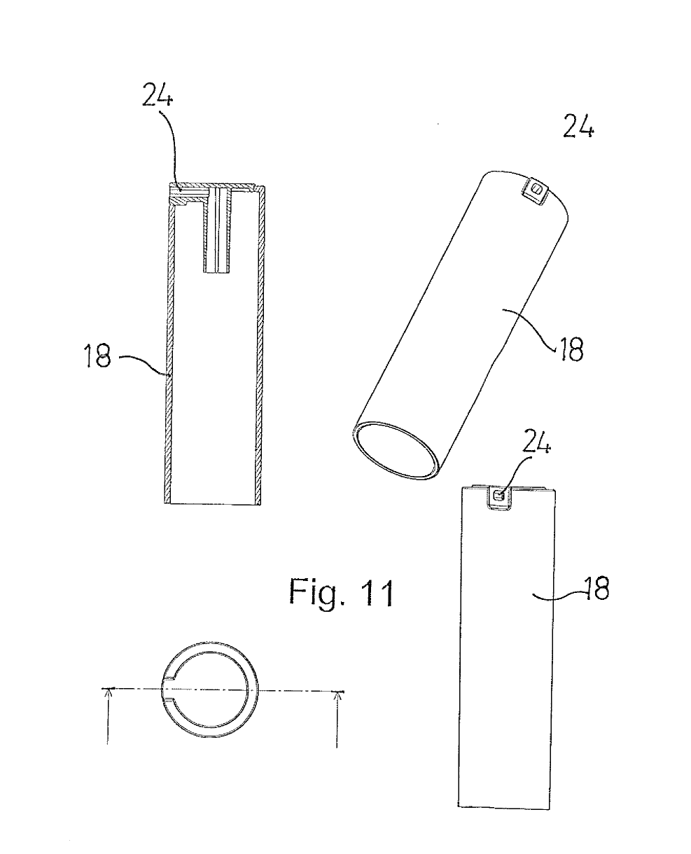

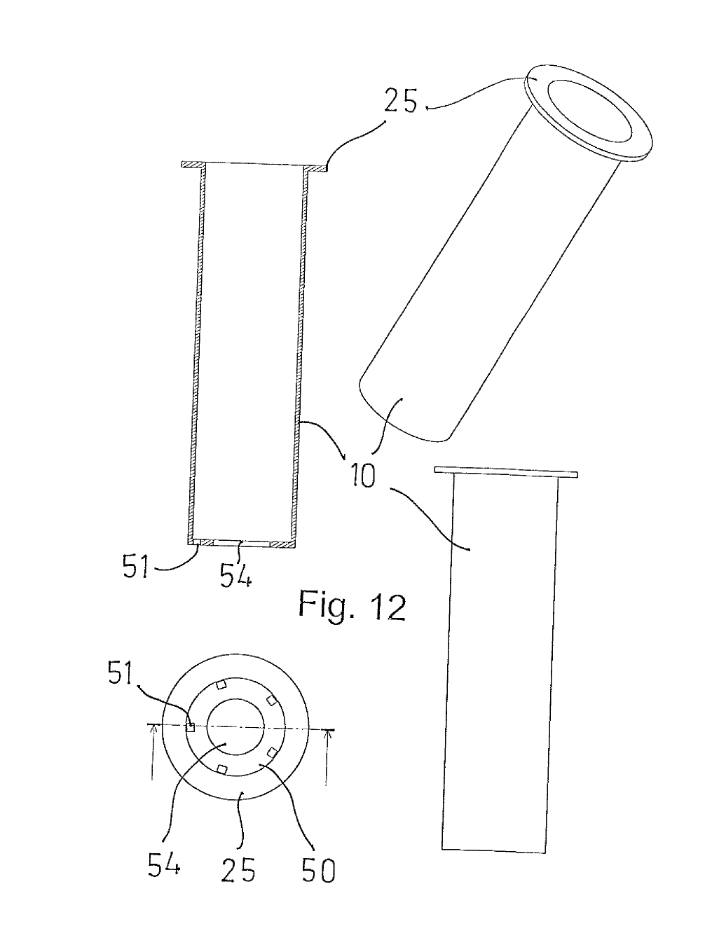

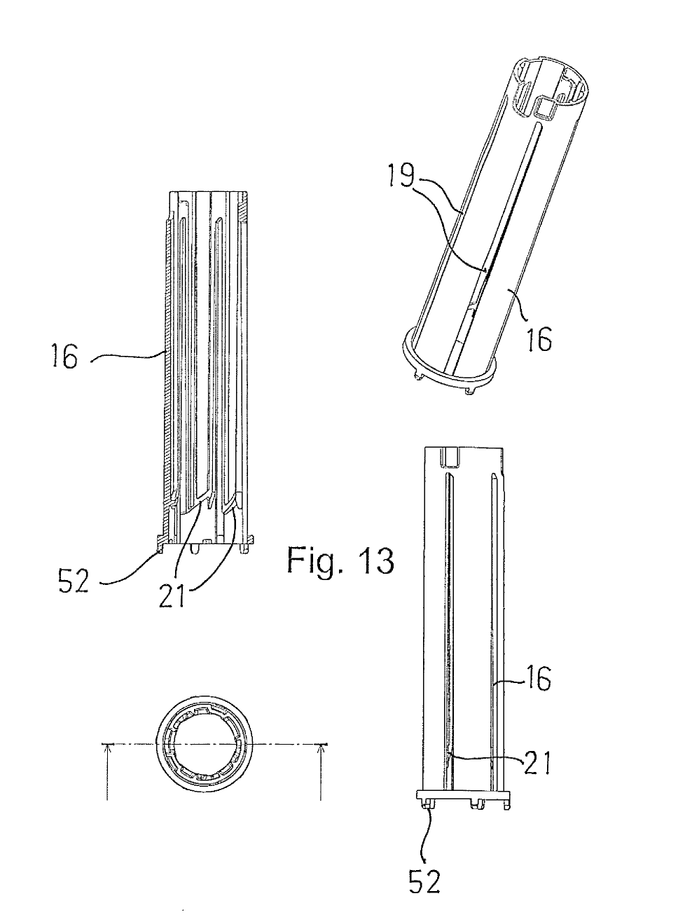

With reference to FIGS. 3 to 13, inside an outer tube 10 or any other tube shaped support housing, preferably made by metal, are receivable a compression spring 11, a tube shaped pump cap 18 axially affectable by the compression spring 11, a rotatable locking body 13 provided with radial projections 12, an impact body 15 provided with beveled ridges 14, as well as an inner support tube 16 provided with axial recesses 19 and received by the outer tube 10. The outer tube 10 and the support tube 16 are arranged in such a way that there is a radial gap between them, preferably the outer tube 10 and the support tube 16 are concentric. The pump cap 18 and the compression spring 11 are arranged in the gap between the outer tube 10 and the support tube 16.

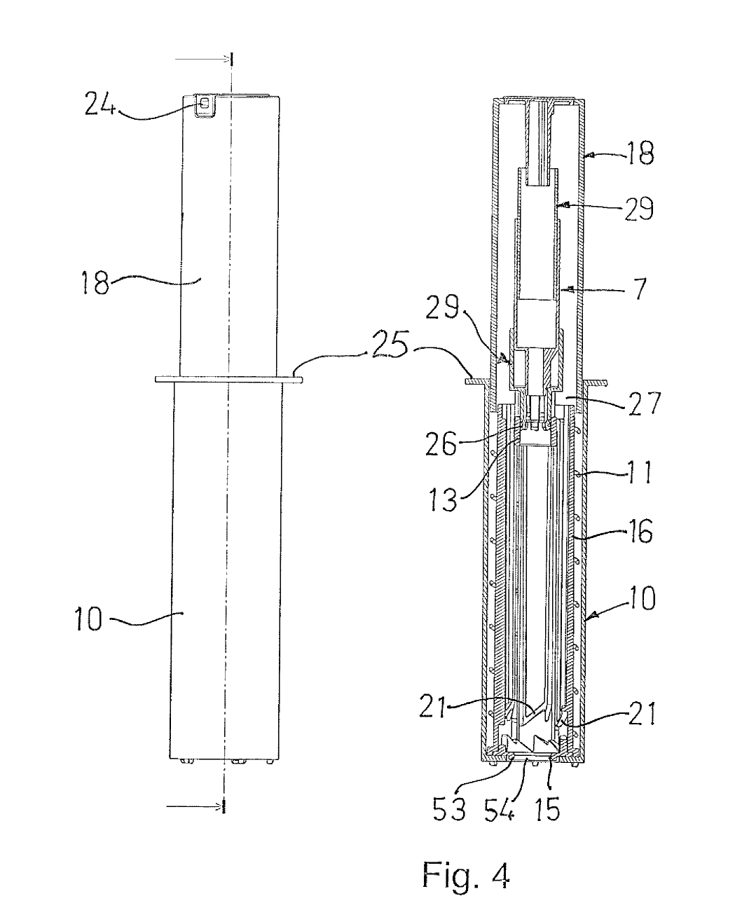

The impact body 15 is constituted by a saw tooth shaped bottom gear ring having ridges 17 extending axially and is fixed at the bottom of the outer tube 10 by means of a centrally located enlargement 53 that is received in a central bottom hole 54 in the outer tube 10, as is shown in FIG. 4. The locking body 13 is constituted by a rotation body provided with projections 12 that are adapted in shape to the ridges 17, the locking body 13 being arranged to cooperate with the impact body 15 for step by step rotation as well as being arranged to have the radial projections 12 thereof alternately received in said axial recesses 19 of the support tube 16 for locking cooperation with associated locking means 21 of the support tube 16.

Beveled axial teeth 22 are distribute along the circumference of the impact body 15 and said locking means 21 is constituted of a number of beveled recesses distributed along the circumference of the support tube 16 for receiving said projections 12 of the locking body 13 in a locking position.

Said discharge mechanism 5 comprises a radially fixed or movable and outside the periphery of the pump cap 18 reaching discharge opening 24 for said pumped fluid 3.

The outer tube 10 present in the outer end 10A thereof a fixed or fastenable ring shaped flange 25 that is arranged for connecting the dispenser 2 at the intended location. The outer tube 10 present in the other end 10B at the bottom 50 thereof a number of receiving openings 51 that are distributed along a ring shape and that are arranged to receive resilient projections 52, arranged at the bottom of said inner support tube 16 and congruent distribute along a ring shape, adapted to connect the part 10 and 16 to each other in mounted state as is shown in e.g. FIG. 3.

Said pump 7 is receivable inside said pump cap 18, means 26 being arranged at the bottom 27 of the pump cap 18, e.g. a ring shaped flange having clamp function, for holding the compression piston 29 of the pump in the compressed storage position.

The function and nature of the invention should be evident from the above given and by means of the drawings.

Said invention shall nevertheless be briefly explained and described.

In the compressed storage position I, as is for instance shown in FIG. 3, the telescopically arranged parts 10, 18, 16 are compressed having the parts closely packed together in a compact way such that the device 1 can be completely concealed inside e.g. a limiting surface of a work top 4.

A central impact piston/button 60 is arranged to be compressed or in another way affected in order to activate discharge of the different parts as is shown in FIG. 4, and in which position the pump 7 may be actuated by pressing the pump cap 18 against the pressure effect of the spring 11. During pressing of the impact piston 60 the locking body 13 is moved, which locking body 13 is connected to the lower compression piston 29 of the pump 7 via the clamp flange 26 and the cooperative ring shaped flange of the locking body 13, in the upward direction 100. Upon compression of the impact piston 60 the locking body turn by means of the projections 12 of the locking body 13 cooperate with the ridges 17 of the impact body 15.

Thereafter the pump 7 is set in the unlocked pump position, by for instance turning the pump cap 18 to the intended squirt position of pump position.

Compression of the pump cap 18 bring the pump piston 29 to pump fluid 3 from the reservoir 9 via the conduit 30 through the device 1 and out through the mouthpiece 8 and the discharge opening 24 thereof, that previously have projected or turned to the intended position for delivery of the fluid. In this connection the projections 12 of the locking body 13 are guided in the axial recesses 19 in the support tube 16. When the locking body 13 together with its projections 12 come in contact with the inclined surfaces 14 of the ridges 17 of the teeth 22 projecting axially from the impact body 15 a step by step rotation is performed for having the projections 12 arranged in the straight axial recesses 19 of the support tube 16 and arranged in the inclined grooves 21 in the support tube, respectively. Thus, an effective and reliable mechanism.

The lowering of the discharge mechanism 5 takes place in the reversed order.

Guiding of the compression piston 29 is accomplished by means of wings 75 provided along the circumference of said compression piston and which are received in said slit shaped recesses 19 extending through the support tube 16. In this way the compression piston 29 is not turned when the locking body 13 turns, and as a consequence of that the compression piston 29 is not turned the pump cap 18 is not turned and by that the discharge opening 24 of the mouthpiece 8 is always directed in one and the same direction in relation to the dispenser 2.

The invention is of course not delimited to the embodiments described above and shown in the appended drawings. Modifications are possible, especially regarding the nature of the different parts, or by using equivalent techniques, without deviating from the protection of the invention, as is defined in the claims.

1. Dispenser (2) for a pumpable fluid (3), adapted to be arranged at a surface (4), and comprising a movable discharge mechanism (5) for said fluid (3), wherein said discharge mechanism (5) is receivable in an inserted concealed storage position (I) inside said surface (4) and in a projected, from the outside (6) of the dispenser (2), freely accessible discharge position (II), respectively, the discharge mechanism (5) comprising a pump (7) that is arranged to take a locked pump position and an unlocked pump position, respectively.

2. Device according to claim 1, wherein the discharge mechanism (5) is constituted by a pump (7) having a mouthpiece (8) and being connected to a reservoir (9) for receiving and discharging said fluid (3) therefrom.

3. Device according to claim 2, wherein the pump (7) comprises means for automatic projection or turning of the discharge mouthpiece (8) of the pump.

4. Device according to claim 3, wherein said means is constituted by a mechanically, electrically or manually manipulated drive unit.

5. Device according to claim 3, wherein inside an outer tube (10) or tube shaped support housing, preferably made of metal, are receivable a compression spring (11), a rotatable locking body (13) provided with radial projections (12), an impact body (15) provided with beveled ridges (14), as well as an inner support tube (16) provided with axial recesses (20) and received by the outer tube (10).

6. Device according to claim 5, wherein the impact body (15) is constituted by a saw tooth shaped bottom gear ring having ridges (17) extending axially, the locking body (13) is constituted by a rotation body provided with projections (12) that are adapted in shape to the ridges (17), the locking body (13) being arranged to cooperate with the impact body (15) for step by step rotation and being arranged to have the radial projections (12) thereof alternately received in said axial recesses (20) and locking cooperation with associated locking means (21).

7. Device according to claim 6, wherein said locking means (21) is constituted by a number of locking recesses (23) distributed along the circumference of the support tube (16) for receiving said projections (12) in a locking position.

8. Device according to claim 5, wherein said discharge mechanism (5) comprises a radially fixed or movable and outside the periphery of the outer tube reaching discharge opening (24) for said pumped fluid (3).

9. Device according to claim 5, wherein the outer tube (10) present in a first end 10A thereof a fixed or fastenable ring shaped flange (25) that is arranged for connecting the dispenser (2) at the intended location.

10. Device according to claim 5, wherein inside said tube (10, 16) is a pump (7) receivable, in the bottom (27, 28) of the tubes being arranged means (26), for instance having clamp function for keeping the compression piston (29) of the pump in compressed storage position.
